(19) United States
(12) Patent Application Publication
(10) Pub. No.: US 2005/0246386 A1
(43) Pub. Date: Nov. 3, 2005

(54) Hierarchical storage management

(76) Inventors: George Sullivan, Bethesda, MD (US); Demsas Abraha, Bethesda, MD (US)

Correspondence Address: VENABLE LLP, P.O. BOX 34385, WASHINGTON, DC, 20045-9998, US

(21) Appl. No.: 11/062,595

(22) Filed: Feb. 22, 2005

Related U.S. Application Data
(60) Provisional application No. 60/545,925, filed on Feb. 20, 2004.
(60) Provisional application No. 60/549,546, filed on Mar. 4, 2004.

(51) Int. Cl. G06F 12/00

(52) U.S. Cl. 707/200

(57) ABSTRACT

A method including reading a policy file for defining criteria to be used for migrating a file from a first storage to a second storage, scanning the first storage, determining whether there is adequate storage space in the second storage, analyzing the first storage based on the policy file to identify a file that is to be migrated, copying the file to the secondary storage, and writing a reparse point corresponding to the copied file in the first storage.

### CROSS-REFERENCE TO RELATED APPLICATIONS

The present application claims priority to U.S. Patent Application No. 60/545,925, entitled “Hierarchical Storage Management,” filed on Feb. 20, 2004, the contents of which are herein incorporated by reference.

### BACKGROUND OF THE INVENTION

1. Field of the Invention

The present invention relates generally to system, method, and computer program product for hierarchical storage management. More specifically, the present invention relates to using reparse points for hierarchical storage management.

2. Related Art

Exponential growth in storage requirements, tightening business continuance, performance, and data retention requirements, and the adoption of Advance Technology Attachment (ATA) devices for enterprise mass storage requirements are causing data centers to optimize their storage investment and manage heterogeneous storage resources.

### BRIEF SUMMARY OF THE INVENTION

Embodiments of the present invention are directed to a hierarchical storage management system and method for electronic files. According to the invention, electronic files are moved from a primary to secondary to tertiary storage medium in response to predetermined criteria that may be selected from a user interface.

Embodiments of the present invention further provide a system and method for optimizing management efficiencies across heterogeneous storage assets by automatically pruning data stores on a primary disk.

Embodiments of the present invention also manage data by time-based, content-based, and regulation-based functions using a distributed and independent architecture.

Exemplary embodiments of the present invention provide a method including reading a policy file for defining criteria to be used for migrating a file from a first storage to a second storage, scanning the first storage, determining whether there is adequate storage space in the second storage, analyzing the first storage based on the policy file to identify a file that is to be migrated, copying the file to the secondary storage, and writing a reparse point corresponding to the copied file in the first storage.

A further exemplary embodiment of the invention provides a method for receiving a request to retrieve a file from one of a first storage or a second storage, determining whether the file resides in the first storage or the second storage based on the presence of a reparse point in the request, the presence of which indicating that the file resides in the second storage, opening the reparse point, extracting a corresponding path to the file in the second storage from the reparse point, initiating a new request for the file based on the corresponding path; and opening the file based on the new request.

Still a further exemplary embodiment of the invention provides a system that includes a network, at least one client computer coupled to the network, a storage management server including a hierarchical storage management software module coupled to the network, a first storage server couple to the network, a hierarchical storage management filter coupled to the first storage server, a first storage coupled to the hierarchical storage management filter, a second storage server coupled to the network, the second storage server including a hierarchical storage management agent, and a second storage coupled to the second storage server.

Further objectives and advantages, as well as the structure and function of preferred embodiments will become apparent from a consideration of the description, drawings, and examples.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts an exemplary embodiment of a hierarchical storage management system according to the present invention;

FIG. 2 depicts an exemplary embodiment of a method for hierarchical storage management according to the present invention;

FIG. 3 depicts an exemplary embodiment of a hierarchical storage management filter according the present invention; and

FIG. 4 depicts an exemplary embodiment of a method for hierarchical storage management according to the present invention.

### DETAILED DESCRIPTION OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

Exemplary embodiments of the present invention provide a system and method for hierarchical storage management (HSM). In an exemplary embodiment of the invention, a HSM system may use a graphical user interface (GUI) to migrate files from primary storage to secondary storage, for example, based on user-configurable criteria. The migrated files are replaced with pointers, such as, for example, reparse points, indicating the location and status of the original files. In such a HSM system, users may transparently access data without any knowledge of the storage management system.

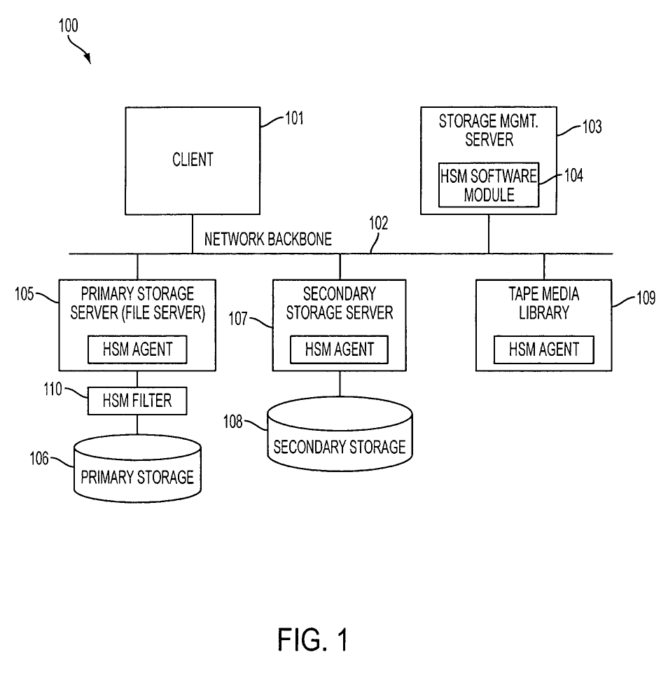

Referring now to the drawings, FIG. 1 depicts an exemplary embodiment of a system 100 for implementing hierarchical storage management (HSM). System 100 may include client 101 connected to network backbone 102. Client 101 may be, for example, any computer device that is capable of storing files on a network. In an exemplary embodiment of the invention, client 101 may be a desktop or laptop computer that is connected to network backbone 102. Network backbone 102 may be a large area network (LAN), a wide area network (WAN), or a wireless network, as would be understood by a person having ordinary skill in the art.

System 100 may also include storage management server 103, which, in an exemplary embodiment of the invention, may include an HSM software module 104 for managing the HSM of system 100, for example. An example of HSM software module 104 may include, for example, ManageTone™, available from Overtone Software of Bethesda, Md., USA. In an further exemplary embodiment of the invention, HSM software module 104 may reside on any of the clients and/or servers of system 100. Storage management server 103 may be a dedicated storage management server, or in an alternative embodiment of the invention, as will be understood by a person having ordinary skill in the art, storage management server 103 may be a shared server, for example.

In an exemplary embodiment of the invention, HSM software module 104 manages the file migration and other HSM functions of file servers. System 100 may include primary storage server 105, which may serve as a file server for primary storage 106. System 100 may also include secondary storage server 107, which may serve as a file server for secondary storage 108. As will be understood by a person having ordinary skill in the art, primary storage 106 and secondary storage 108 may be connected to network backbone 102 via primary storage server 105 and secondary storage server 107, respectively.

In an exemplary embodiment of the invention, types of primary storage may include, for example, but are not limited to, fiber channel disks, Small Computer System Interface (SCSI) devices, Storage Area Networks (SAN), Network Attached Storage (NAS), and the like. Examples of secondary storage may include, for example, but are not limited to, Advance Technology Attachment (ATA) devices, serial ATA devices, and the like.

System 100 may also include tape media library 109, which may be used for backup of system 100, for example. In an exemplary embodiment of the invention, tape media library 109 may be referred to as tertiary storage and may be implemented as an HSM device. As will be understood by a person having ordinary skill in the art, other storage devices, such as those mentioned above, may be used as tertiary storage.

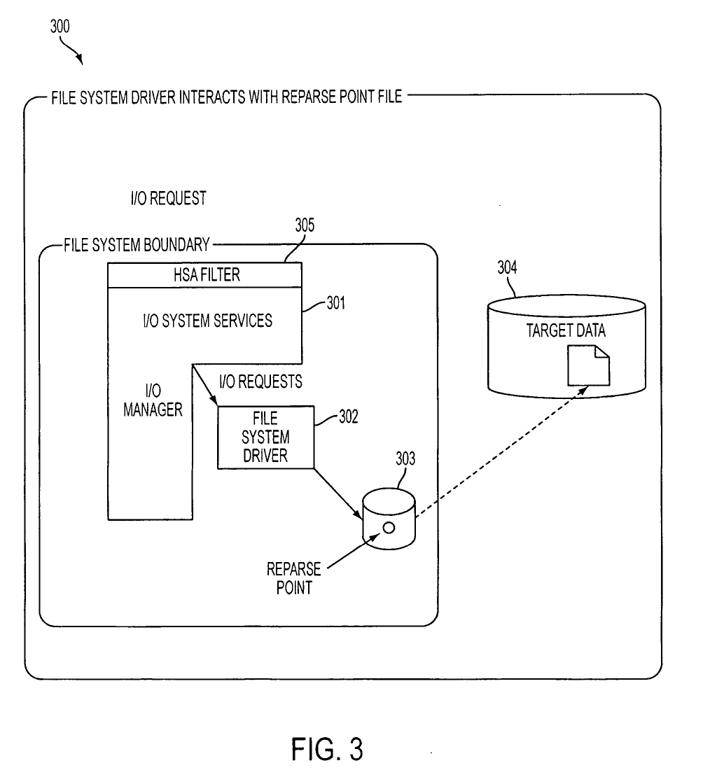

In an exemplary embodiment of the invention, system 100 may include a HSM filter 110. HSM filter 110 may cooperate with storage management server 103 to process input/output (I/O) requests from client 101, as will be discussed in detail below when referring to FIG. 3.

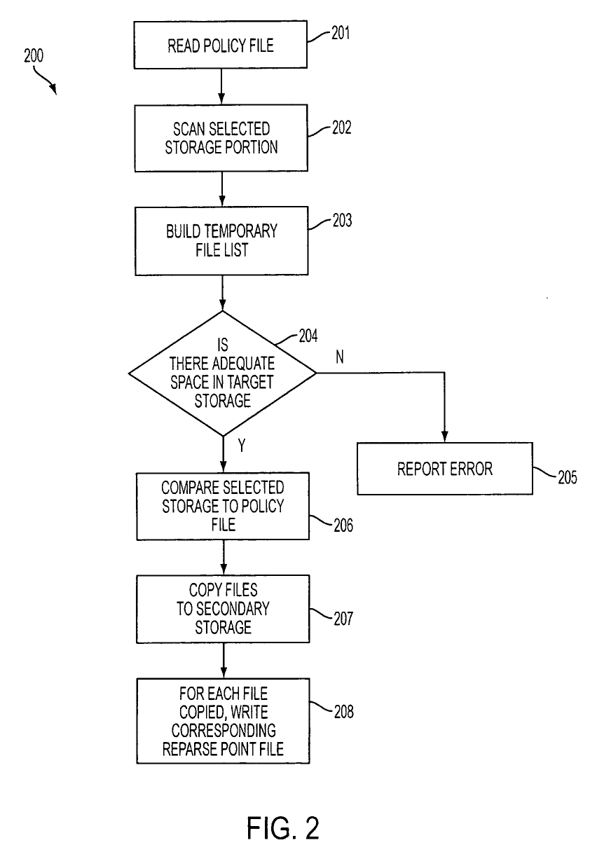

FIG. 2 depicts flow chart 200, which illustrates an exemplary method for migrating files in a HSM system. In block 201, a HSM software module, for example, reads a policy file that defines the criteria to be used for migrating files from primary storage to secondary storage, for example. The policy file maybe user-conifgurable and include criteria based on, inter alia, time (i.e., when the file was created, modified, and/or accessed) and file attributes, such as, e.g., the size and type of file.

In block 201, a HSM software module scans the selected storage (i.e., the source) portion. In block 203, a HSM software module builds a temporary file list of the files that are to be migrated. In block 204, a HSM software module determines if there is adequate storage space in secondary storage (i.e., the target). In block 205, if there is not enough storage in secondary storage, an error will be generated.

In block 206, if there is enough storage in the primary storage, a HSM software module compares the selected storage to the policy file. In block 207, the files to be migrated are copied to secondary storage. In block 208, for each file that is to be copied, the HSM software module writes a corresponding reparse point file.

In an exemplary embodiment of the invention, it is contemplated that a compression algorithm may be implemented to reduce the size of the files that are migrated to secondary storage.

FIG. 3 depicts an exemplary file system 300, for retrieving a file that has been migrated using HSM, for example. File system 300 may include I/O system services, file system driver 302, primary storage 303, secondary storage 304, and HSM filter 305. File system 300 may enable a HSM system, such as, HSM system 100, to retrieve files that are stored on the network and have been migrated using HSM, for example.

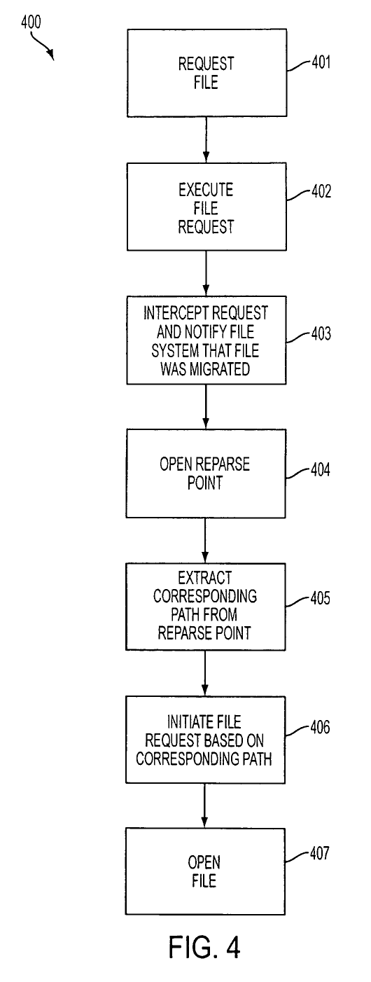

FIG. 4 depicts flow chart 400, which illustrates an exemplary method for retrieving a file that has been migrated using HSM. In block 401, any computer on a network may request a file from storage. As discussed above, the user requesting the file may or may not know that the file has been migrated.

In block 402, a file system executes the request command. As will be understood by a person having ordinary skill in the art, a file request may be an I/O request to retrieve the file from a hardware device.

In block 403, an HSM filter, such as, HSM filter 110 or HSM filter 305, intercepts the request and notify the file system that the file has been migrated.

In block 404, the file system opens the reparse point.

In block 405, the file system extracts a corresponding path (from the reparse point file, for example) to the actual file in the target storage.

In block 406, the file system initiates a second request for the desired file based on the corresponding path.

In block 407, the file is opened.

In an exemplary embodiment of the invention, a HSM system can be integrated with an information life-cycle management system. As will be understood by a person having ordinary skill in the art, information life-cycle management is the creation and management of a storage infrastructure and the data that it maintains. All information, or data, in a storage network has a specific lifecycle, from the time the information enters an organization's system to the time it is archived or removed from the system. The information may have a finite lifecycle—where the data are eventually removed from a storage network when the information becomes outdated or no longer needed—or an infinite lifecycle if the information remains valuable to the organization retaining it.

In general, there are three stages in the information lifecycle. First, there is the creation and/or acquisition of the data—information comes into the organization either by being created by one or more individuals or by being acquired through e-mails, faxes, letters, phone calls, etc.

Second is the publication of the data—some information needs to be published, either in print form or on a company's intranet or a public Web site.

Third is the retention and/or removal of the data—some information must be archived for later use, and some information has a finite purpose and can be discarded once it has served its purpose or is no longer valuable to the organization.

The management of the information lifecycle involves keeping the data accessible to the users who need the information and determining how the information is stored based on how high of a priority the information has in the organization at any given moment. At each stage in the information's lifecycle, the management infrastructure must determine the best software, hardware and storage medium required for the information at that stage, and how those factors differ as the data move through the lifecycle.

In such an environment, a HSM system can include a logical terminal for secured access to secondary storage. If the logical terminal attempts to access a file that has been migrated by HSM for example, a HSM software module may interact with information life-cycle management software to check the security associated with the file and then retrieve the file.

In an exemplary embodiment of the invention, once files have been migrated using HSM, an HSM software module to create an activity log of the files that have been migrated.

In a further embodiment of the invention, a HSM software module may include a rollback feature. In such an embodiment, the HSM software module may have a restore tool, for example, that can use the activity log, for example, to return the migrated files from the target storage area to the source storage area.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A method comprising:
reading a policy file for defining criteria to be used for migrating a file from a first storage to a second storage;
scanning the first storage;
determining whether there is adequate storage space in the second storage;
analyzing the first storage based on the policy file to identify a file that is to be migrated;
copying the file to the secondary storage; and
writing a reparse point corresponding to the copied file in the first storage.

2. The method according to claim 1, further comprising:
building a temporary list including the file that is to be migrated from the first storage to the second storage.

3. The method according to claim 1, further comprising:
compressing the file before said copying.

4. The method according to claim 1, wherein the policy file is user configurable.

5. The method according to claim 4, wherein the criteria are based on at least one of time file was created, time file was modified, time file was accessed, size of file, or type of file.

6. The method according to claim 1, wherein the policy file is automatically generated.

7. The method according to claim 1, further comprising:
generating an error if there is not adequate storage space in the second storage.

8. A method comprising:
receiving a request to retrieve a file from one of a first storage or a second storage;
determining whether the file resides in the first storage or the second storage based on the presence of a reparse point in the request, the presence of which indicating that the file resides in the second storage;
opening the reparse point;
extracting a corresponding path to the file in the second storage from the reparse point;
initiating a new request for the file based on the corresponding path; and
opening the file based on the new request.

9. The method according to claim 8, wherein a hierarchical storage management filter determines whether the file resides in the first storage or the second storage.

10. A machine accessible medium containing program instructions that, when executed by a processor, cause the processor to perform a series of operations comprising:
reading a policy file for defining criteria to be used for migrating a file from a first storage to a second storage;
scanning the first storage;
determining whether there is adequate storage space in the second storage;
analyzing the first storage based on the policy file to identify a file that is to be migrated;
copying the file to the secondary storage; and
writing a reparse point corresponding to the copied file in the first storage.

11. The machine accessible medium according to claim 10, further containing program instructions that, when executed by the processor cause the processor to perform further operations comprising:
building a temporary list including the file that is to be migrated from the first storage to the second storage.

12. The machine accessible medium according to claim 10, further containing program instructions that, when executed by the processor cause the processor to perform further operations comprising:
compressing the file before said copying.

13. The machine accessible medium according to claim 10, wherein the policy file is user configurable.

14. The machine accessible medium according to claim 13, wherein the criteria are based on at least one of time file was created, time file was modified, time file was accessed, size of file, or type of file.

15. The machine accessible medium according to claim 10, wherein the policy file is automatically generated.

16. The machine accessible medium according to claim 10, further comprising:
generating an error if there is not adequate storage space in the second storage.

17. A machine accessible medium containing program instructions that, when executed by a processor, cause the processor to perform a series of operations comprising:
receiving a request to retrieve a file from one of a first storage or a second storage;
determining whether the file resides in the first storage or the second storage based on the presence of a reparse point in the request, the presence of which indicating that the file resides in the second storage;
opening the reparse point;
extracting a corresponding path to the file in the second storage from the reparse point;
initiating a new request for the file based on the corresponding path; and
opening the file based on the new request.

18. The machine accessible medium according to claim 17, wherein a hierarchical storage management filter determines whether the file resides in the first storage or the second storage.

19. A system comprising:
a network;
at least one client computer coupled to said network;
a storage management server including a hierarchical storage management software module coupled to said network;
a first storage server couple to said network;
a hierarchical storage management filter coupled to said first storage server;
a first storage coupled to said hierarchical storage management filter;
a second storage server coupled to said network, said second storage server including a hierarchical storage management agent; and
a second storage coupled to said second storage server.

20. The system according to claim 19, further comprising a third storage, said third storage including hierarchical storage management agent.

21. The system according to claim 19, further comprising an input/output manager module coupled to said hierarchical storage management filter.
